(19) United States
(12) Patent Application Publication
(10) Pub. No.: US 2024/0321495 A1
(43) Pub. Date: Sep. 26, 2024

(54) GEOMAGNETIC FIELD AMPLIFIER DEVICE, SYSTEM, AND METHOD

(71) Applicant: Eric Jason Crews, Blacksburg, VA (US)

(72) Inventor: Eric Jason Crews, Blacksburg, VA (US)

(21) Appl. No.: 18/440,342

(22) Filed: Feb. 13, 2024

Related U.S. Application Data
(60) Provisional application No. 63/484,824, filed on Feb. 14, 2023.

(51) Int. Cl. H01F 7/06; B64G 1/10

(52) U.S. Cl. CPC H01F 7/06; B64G 1/105; B64G 1/1085

(57) ABSTRACT

A geomagnetic field amplifier device, system, and method is provided. The invention includes geosynchronously orbiting one or more satellites about a first magnetic pole of the planet; and transmitting, from each said satellite, a first mono-polarity magnetic field at the first magnetic pole, wherein the first mono-polarity magnetic field and first magnetic pole correspond in polarity.

### CROSS-REFERENCE TO RELATED APPLICATION

This application claims the benefit of priority of U.S. provisional application No. 63/484,824, filed 14 Feb. 2023, the contents of which are herein incorporated by reference.

### BACKGROUND OF THE INVENTION

The present invention relates to geomagnetic field amplification and, more particularly, a geomagnetic field amplifier device, system, and method.

Earth's magnetic field, also known as the geomagnetic field, is the magnetic field that extends from Earth's interior out into space, where it interacts with the solar wind, a stream of charged particles emanating from the Sun.

Earth's magnetic field deflects most of the solar wind, whose charged particles would otherwise strip away the ozone layer that protects the Earth from harmful ultraviolet radiation. One stripping mechanism is for gas to be caught in bubbles of magnetic field, which are ripped off by solar winds. Calculations of the loss of carbon dioxide from the atmosphere of Mars, resulting from scavenging of ions by the solar wind, indicate that the dissipation of the magnetic field of Mars caused a near total loss of its atmosphere.

Earth's magnetic field is produced by mantle convection and the heat that is producing magma flow and is incurred in part by radioactive material decay that has a half-life reducing the thermal ranges, affecting planetary magnetic field (the magnetosphere) stability. The magnetic turbulence of modern equipment producing electromagnetic eddies that weaken the greater magnetosphere by causing magnetic flow turbulence. The radioactive decay rate of planetary core elements is also a factor in depleting the Magnetosphere as the radioactive material that is producing planet core heat and allowing the planet's core geo dynamo to cycle (mantle convection), causes heat loss over long time spans (radioactive half-life), which in turn effects the Earth's magnetic shielding from the Sun itself. The convection rate might have varying degrees of effectivity due to the current volume of heat producing material factoring pressure and Earth's rotation.

There is evidence that the geomagnetic field of the Earth is failing, which could result in a similar fate to Mars's.

As can be seen, there is a need for a geomagnetic field amplifier configured to correct the possibly failing geomagnetic field of the Earth.

### SUMMARY OF THE INVENTION

The present invention affords a low-cost application as the individual units are small, while the combination of multiple units could generate sufficient power to electrify electromagnets to increase the magnetic field.

The present invention increases the magnetic field of the Earth to “re-align” or “re-Gauss” the Earth's magnetic field by transmitting (from a low Earth orbit satellite) a monopole (only one magnetic pole exposed) magnetic field to increase the Earth's magnetic field.

The device embodied in the present invention may be a satellite configured to augment the natural magnetic field of the Earth that plays a vital role in assisting in solar storm protection. The satellite is enabled to “transmit” a magnetic field polarly aligned with the target magnetic pole to increase magnetic flow at two altitudes: a higher placement to reduce low level electromagnetic induction; and a lower system placement for increasing the magnetic gauss of the natural geomagnetic field of the Earth. The device of the present invention is a low-cost unit that can be coupled with a multiple of units working in concert to complete a “total” system.

In one aspect of the present invention, claimed is a satellite for increasing a planetary magnetic field, the satellite providing a mono pole electromagnet array configured to transmit a mono-polarity magnetic field.

In another aspect of the present invention, a method for increasing a planetary magnetic field, the method including transmitting a first mono-polarity magnetic field from the above-mentioned satellite when said satellite is in geosynchronous orbit with a first magnetic pole of the planet, wherein the first mono-polarity magnetic field corresponds in polarity with the first magnetic pole.

In yet another aspect of the present invention, a system for increasing a planetary magnetic field, the system provides geosynchronously orbiting a plurality of the above-mentioned satellites about a first magnetic pole of the planet; and transmitting, from each said satellite, a first mono-polarity magnetic field at the first magnetic pole, wherein the first mono-polarity magnetic field and first magnetic pole correspond in polarity.

These and other features, aspects and advantages of the present invention will become better understood with reference to the following drawings, description and claims.

### BRIEF DESCRIPTION OF THE DRAWINGS

FIG. 1 is a primary schematic view of an exemplary embodiment of the present invention.

FIG. 2 is a secondary schematic view of an exemplary embodiment of the present invention, illustrating an electricity generator/generator “bay” aspect of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

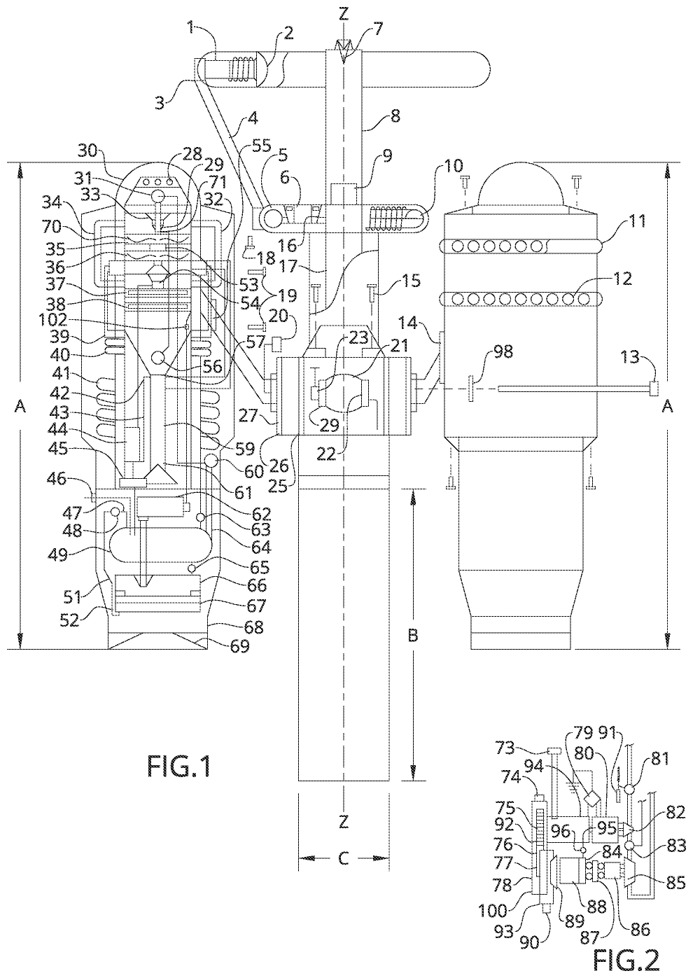

Referring to FIGS. 1 and 2, the present invention may include a geomagnetic field amplifier intended to assist in the increase of the geomagnetic field of the Earth. The geomagnetic field amplifier is embodied in a satellite configured to maintain electrical production to “transmit” a magnetic field configured the total field strength. The satellite described herein is placed in low Earth orbit to increase the magnetic polarization of the North and South magnetic poles of the Earth.

The polarity of the transmitted magnetic field is configured to correspond with the target polarity—i.e., a North pole geographic is transmitted a north-polarity magnetic field from about the North pole. Multiple devices may be combined/cascaded and placed above each pole of the Earth to then “re-Gauss” the planet, thereby “juicing” the geomagnetic field to “re-align” and increase the magnetic flow.

### Components of the Present Invention

1. mono pole electromagnet array providing multiple electromagnets about 360 degrees sum of 24 (only one pole emitting the opposite magnetic pole then magnetically insulated)
2. open bore hole
3. upper mounting structural frame bracket placed at unit circular quadrant points (also containing electrical transference wires within the structural member)
4. hollow bracket
5. toroid electromagnet outer casing
6. microwave transmitter “ring”
7. transmitter wave divider also as a mounting “union bracket” to stabilize the upper electromagnets circular ring” to the core electromagnet
8. hollow core electromagnet (only one pole exposed—opposite pole magnetically sealed—heavy load diodes upon the electrical wire+and resistor upon the—“return” electric wire protects the control electronics from environmental over induction—i.e., solar flare safety circuit)
9. high gain microwave transmitter
10. encased toroid electromagnet (lower “magnetic pole” magnetically insulated)
11. outer lamp ring casing-translucent
12. lamps
13. core hinge “bay” through bolt
14. connecting servo “arm” bushing-heavy gasket
15. union bolt
16. toroid electromagnet casing open bore-circular pattern about 360 degrees
17. shielded core electromagnet encased by hard encasement
18. union bolt
19. mounting bolts
20. lock nut
21. rotating oil and air pressure “tumbler” pressure storage vessel (sum to two total system within letter “B” for redundancy cross wired so that both “tumblers” can feed, oil or air pressure to the system's generator system Letter “C” [fluid oil pressure/air pressure])
22. through bore pressure transference slip ring-multiple exhaust oil/or air also with generator Letter “C” send or return oil pressure with pneumatic fill valve as one way valve “letter “G” also upon a “tee” union upon the exterior to “fill” the “tumbler” via one way valve, with air pressure and or oil “outer plate also as a mounting union point to the structural frame to stabilize the “tumbler”
23. revolutions per minute sensor (RPM sensor) and electric drive motor unit causing the “tumbler to be able to “spin up” even in zero gravity to align the oil/air pressure for the hydraulic draft generator system to function correctly
24. bearing race-pressure retaining mounting bore so that the electric motor's drive shaft then driving the “tumbler mount” bearing race mounting bracket and the half of the bearing race (closed to the electric motor), then used to mount the system to the structural frame of the housing
25. through bore current transfer slip ring and positional sensor used when rotating the oil jet with the electric servo motor
26. servo electric positional electric motor
27. through bore current transfer slip ring and positional sensor used when rotating the oil jet with the electric servo motor
28. lamps
29. hydraulic impeller (hydraulic fluid “oil” impeller) causes union rotation with number 35
30. translucent lamp “dome”
31. venturi max pressure safety discharge valve and temperature sensor—safety vents oil pressure to the core thrust chamber via oil flow pipe
32. oil exhaust flow pipe
33. oil flow guide and max pressure safety vent system—the flow guide contains ports to direct over pressure to the max pressure safety valve
34. oil exhaust flow pipe
35. oil compressor and permanent magnet magneto (electricity generator), with current feed to the circumference mounted electromagnets (incline electrical current the directed through number 36 connecting unit “slip ring system” contained within number 53)
36. oil impeller and circumference electric drive motor “brush less” advances by hydraulic draft “fluid suction”
37. oil compressor and circumference “brush less” electric motor
38. oil drive impeller advances the “drive line assembly” by oil flow speed
39. main venturi max pressure/over pressure safety vent valve flow “coil” oil flow pipe
40. external mechanical oil pump oil flow pipe
41. main oil flow coil type oil flow pipe
42. electric oil displacement “oil discharge”/system throttle valve
43. air pressure filled oil displacement “thrust chamber” oil injects into air pressure
44. external inline oil filter with speed of flow bypass
45. oil intake assembly
46. air pressure valve-one way valve
47. one way valve
48. electric actuation pneumatic pressure control valve
49. dual component air pressure/oil pressure tank-air pressure causes oil pressure. A high-pressure vessel to then in math surpasses the required work capacity factoring all mechanical and electromagnetic resistance produced within the total system.
50. one way valve
51. air pressure flow pipe
52. air pressure coupling
53. lubricated 1:10 ratio gear set aligned so that the output rotation then tandem to the permanent magnet Magneto oil pump number 35 and the input rotation then tandem with number 36-contains thru bore current transfer slip ring to increase the magnetic field emanating from the permanent magnet electromagnetic about the circumference of the generating oil compression fan yields higher electricity output from number 35
54. mechanical oil pump
55. oil jet mounting bracket
56. main venturi over pressure safety valve vents over pressure
57. main throttle valve shutter valve
58. one way valve
59. baffle diffuser with open bore holes
60. external oil fill plug threaded screw bolt uses safety lock washer
61. diffuser “baffle” divider cone sends the oil flow perpendicular
62. heated (electric heating resistor) electric oil injector-heats system's oil
63. electric pneumatic pressure valve
64. oil flow chamber “fill” oil flow pipe
65. electric oil flow valve
66. oil pressure chamber-pressurized by air pressure
67. plate piston moves by air pressure-contains ring and gland bushing hydraulic fluid pressure rated piston plate ring system
68. communications electronics
69. transmitter/antenna system
70. lubricated 1:10 ratio gear set aligned so that the output rotation then tandem with number 37 and input rotation then tandem with number 38-contains RPM (revolutions per minute) sensor to “regulate” oil jet speed reports to main logic electronic circuit paths
71. external venturi over pressure valve discharge oil flow pipe directs oil to the hydraulic fluid/oil impeller number 29 union joined by external mount oil pressure compression couplings
72. system-oil jet chamber divider plate separated the wick assembly from the thrust assembly
73. electricity transfer multi wire “bus” clip
74. oil fill cap threaded
75. large sprocket
76. drive chain tension sprocket
77. receiving sprocket
78. drive chain and sprocket encasement oil retainer case-nonflammable non electrically conductive lubrication
79. voltage regulator
80. permanent magnet “wound electromagnet” magneto “stepper” tilt system also “reacting from the oil jets electrical output to cause increased total system electricity availability-base root cyclical pressure PSI then to compound in electrical generation level of total cycle
81. oil pressure “start cycle” control valve
82. oil impeller
83. oil flow speed regulator inlet dampener valve-maintains oil flow pipe structural integrity
84. pneumatic “start” impeller
85. high volume oil pump—causes system advancement by the hydraulic draft of a pressurized fluid—system accelerator of drive lined union joined components in tandem with the reintroduction of produced electrical current
86. 1:10 ratio gear set output rotation tandem with number 85's internal pump wheel and input rotation tandem with fixed union drive line assembly containing #88
87. RPM sensor system speed control regulates the position of the oil flow valve and the logic mapping electronics potentiometer feeding current to the system “advancer” electric motor number 88
88. drive line electric motor dual shaft
89. oil pump union joined drive shaft to number 77 and, internal pump wheel #89 and input coupling to number 86
90. oil filter
91. electric valve control solenoid
92. drive chain
93. oil flow pipe
94. high voltage electricity generator
95. pneumatic flow pipe
96. pneumatic “start valve” electric actuation
97. avionics main logic electronic circuit “box” flight control circuit boards and electricity management electronics thermal regulation system not to overheat the electronics inductance cage encased
98. lock washer
99. carbon foam radiation and electromagnetic pulse shielding insulation (induction cage system upon the inner surface of the outer hull)
100. magnetic oil plug/oil drain plug
101. external oil pressure injection fitting compression coupling directs hot oil from the oil injector into the chamber
Letter “A”=oil jet
Letter “B”=dual tumbler oil/air pressure chamber contains battery and battery charging system to “start” the generator system and electrify the logic electronic circuit boards—e.g., system on/off, communications via a transmitter, and remote-control logic. Note, the electronic circuit board may be configured to report system parameters to the remote-control unit for safe functioning.
Letter “C”=electricity generator/generator “bay” contents-inductance cage encased.
Letter “Z”=mirror line

A method of using the present invention includes a reusable satellite that emits a magnetic field to increase the Earth's magnetic field. Multiple devices may be placed above each pole of the Earth to then “re-Gauss” the planet “juicing” the geomagnetic field to “re-align” and increase the magnetic flow. Two orbital satellites with the similar magnetic alignment may be transmitted to re-Gauss the Earth.

The satellite devices of the present invention may use seal force vectoring to obtain and maintain a required flight vector with the power/electrical energy derived from a zero-gravity type hydraulic draft accelerator that implements cyclical work potential with the generated angular momentum harvested as electricity. The design described then is placed in low Earth orbit to increase the magnetic polarization of the North and South magnetic poles of the Earth.

The design achieves altitude and maintains elevational geographic location utilizing sustained propulsion. Moreover, compound electrical generation causing the retainment of work potential without work potential loss as the pressurized hydraulic oil system implements fluid dynamics to produce electricity, then converted into motion, to cause oil pressure injected in closed cycle to yield physical “lift” of the unit. Excess electricity may then be converted to electromagnetism to emit a transmitted magnetic field to Gauss the planetary geomagnetic field.

The design polarity then is configured in variance to correspond with the transmitted magnetic field, i.e., north polarity then above the north pole geographic and then the “transmitted” south pole above the south pole geographic. The design below then depicts the north pole alignment format.

The device is configured to transmit and receive information with system avionics, wherein the device is configured to process the information for required system functioning i.e. positioning a transmitter r level, power to the electromagnetics, engine control lamp system, etc. The satellite devices may use avionics to maintain physical position above the magnetic poles of the Earth in low orbit. The system will communicate with other similar units under a proxy-safety protocol to avoid collisions. The system will be able to be guided by remote control radio to drive control units' functions for remote operation also allowing individual units to reenter earth's atmosphere slowly for repairs.

The system of a plurality of satellites may be placed at greater altitude in redundant systems i.e., higher placement than for just feeding the Magnetosphere. The higher orbital placement can act as a primary deflection system to prevent low level (ground level) magnetic “storms”. Effectively a satellite shielding system. The following design system is intended to assist in the increase of the geomagnetic field of the Earth.

Electric components required for the system to operate may connect to the main logic mapping circuit control board.

The system physical scale may be small to allow for cost effective implementation, approximately 36″ (inches)-96″ (inches).

The design may have an auxiliary application to clean orbital space debris or control re-entering defunct satellites. The system also could be adapted to serve as an emergency aircraft landing system demonstrating slow descent vertical vector displacement to “hover land” the aircraft as a redundant flight safety tool. Additionally, the present invention may be operatively associated with a hover craft engine system.

Furthermore, the geomagnetic field satellite may be used in tandem with a solar radiation diffuser satellite to slow and cool a coronal mass ejection prior to impalement with the solar radiation diffuser satellite. Turbulence traversing a “wave” slows the wave, wherein magnetic interference produced by the geomagnetic field amplifier can slow or redirect a solar flare, spreading it apart and dropping its thermal properties to prevent excessive thermal fatigue upon the outer surface of the solar radiation diffuser satellite.

Surface area protection may be required in the use of a multitude of satellites.

Additionally, the present invention may be used for asteroid migration.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A satellite for increasing a planetary magnetic field, the satellite comprising:
a mono pole electromagnet array configured to transmit a mono-polarity magnetic field.

2. A method for increasing a planetary magnetic field, the method comprising:
transmitting a first mono-polarity magnetic field from the satellite of claim 1 when said satellite is in geosynchronous orbit with a first magnetic pole of the planet, wherein the first mono-polarity magnetic field corresponds in polarity with the first magnetic pole.

3. A system for increasing a planetary magnetic field, the system comprising:
geosynchronously orbiting a plurality of satellites of claim 1 about a first magnetic pole of the planet; and
transmitting, from each said satellite, a first mono-polarity magnetic field at the first magnetic pole, wherein the first mono-polarity magnetic field and first magnetic pole correspond in polarity.
